(19) United States
(12) Patent Application Publication
(10) Pub. No.: US 2004/0027441 A1
(43) Pub. Date: Feb. 12, 2004

(54) Recording apparatus

(75) Inventors: Takeji Niikura, Kanagawa (JP); Seiji Ogasawara, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/427,976

(22) Filed: May 2, 2003

(30) Foreign Application Priority Data
May 9, 2002 (JP) 133754/2002 (PAT.

(51) Int. Cl. B41J 2/01

(52) U.S. Cl. 347/107; 347/104

(57) ABSTRACT

The present invention relates to a recording apparatus recording an image by discharging an ink, comprising a recording means for being recordable to at least one edge of a recording medium without any margin, an receiving portion for receiving an ink droplet discharged at a position protruded from the recording medium, a conveyance rotary body located on an upstream side of the opening in a conveyance direction of the recording medium. The conveyance rotary body is made conductive to an apparatus body.

### BACKGROUND OF THE INVENTION

1. Field of the Invention

This invention relates to a recording apparatus recordable on at least one edge of a recording medium with no margin.

2. Related Background Art

Referring to FIG. 8, FIG. 9, a prior art is described. Conventionally, in a recording apparatus recordable with no margin at edges of a recording medium such as a sheet or the like, an inkjet recording apparatus capable of recording with no margin has been known with a structure in which an opening is formed over a sheet passing surface of a platen 6 for holding the sheet at a recording position, in which a recess 26 made of vertical surfaces and a bottom surface is formed below the opening, and in which ink absorbing materials (hereinafter, referred to as “platen ink absorbing material 27”) are formed at the recess 26. Such a concrete structure is disclosed in JP-A-2000-118058.

With this inkjet recording apparatus, a gap of a certain amount is formed between the back side of the sheet and the platen ink absorbing material 27 to prevent the sheet from getting dirty due to contacts. Therefore, if recording is made to a position protruded from an edge as recording with no margin with respect to edges of the sheet, it may get the sheet messed with ink droplets where discharged ink droplets may go around the back side of the sheet. This mess is outstanding at electrostatically charged sheets from e.g., frictions among the sheets or frictions between the sheets and the feeding roller.

To solve this problem, a structure is devised in which a discharging blush made of e.g., fine metal lines or carbon lines, is arranged on an upstream side of the recording section to remove electrostatic charges from the sheets electrostatically charged during sheet feeding or the like. With this prior art, however, the discharging blush described above has to have a certain width or more and is necessarily in grounded connection with a chassis member of the apparatus to remove the electric charges from the sheets, so that the structure is inevitably subject to largely increased costs.

With respect to the above situation, an invention for an apparatus with an inexpensive structure for preventing the back side of the sheet from messing is sought.

### SUMMARY OF THE INVENTION

This invention is to solve the above problems in the prior art. It is an object of the invention to provide a recording apparatus recordable with no margin at edges with an inexpensive Structure for preventing the back side of the sheet from messing.

A representative structure of the invention for achieving the above object is a recording apparatus recording an image by discharging an ink including: a recording means for being recordable to at least one edge of a recording medium without any margin; an opening escaping an ink droplet discharged at a position protruded from the recording medium; a conveyance rotary body located on an upstream side of the opening in a conveyance direction of the recording medium, wherein the conveyance rotary body is made conductive to an apparatus body.

For example, the conveyance rotary body located on the upstream side of the opening in the recording medium conveyance direction may be made conductive to the chassis of the apparatus body with a plate shaped conductor, or the conveyance rotary body located on the upstream side of the opening in the recording medium conveyance direction may be made conductive to the chassis of the apparatus body with a bearing member of a conveyance rotary body.

With the above structure, because it is unnecessary to specially form a member discharging static electricity from the electrostatically charged recording medium, the static electricity charged at the recording medium can be made to escape effectively from the conveyance rotary body even though the structure is inexpensive, thereby preventing the recording medium from messing caused by attachments of a part of ink droplets discharged as protruded from the recording medium to the back side of the electrostatically charged recording medium.

### BRIEF DESCRIPTION OF THE DRAWINGS

FIG. 1 is a perspective view showing an inkjet recording apparatus according to an embodiment of the invention;

FIG. 2 is a side cross section showing the inkjet recording apparatus according to an embodiment of the invention;

FIG. 3 is a schematic diagram showing an image forming range during recording with no margin at edges in the embodiment of the invention;

FIG. 4 is a perspective view showing a portion in association with the recording with no margin in the embodiment of the invention;

FIG. 5 is a side cross section showing a portion in association with the recording with no margin in the embodiment of the invention;

FIG. 6 is a perspective view showing a portion in association with the recording with no margin in the embodiment of the invention;

FIG. 7 is a partly left side view exemplifying a conductive structure between a conveyance roller and a metal chassis in the embodiment of the invention;

FIG. 8 is a perspective view showing a portion in association with the recording with no margin of the prior art; and

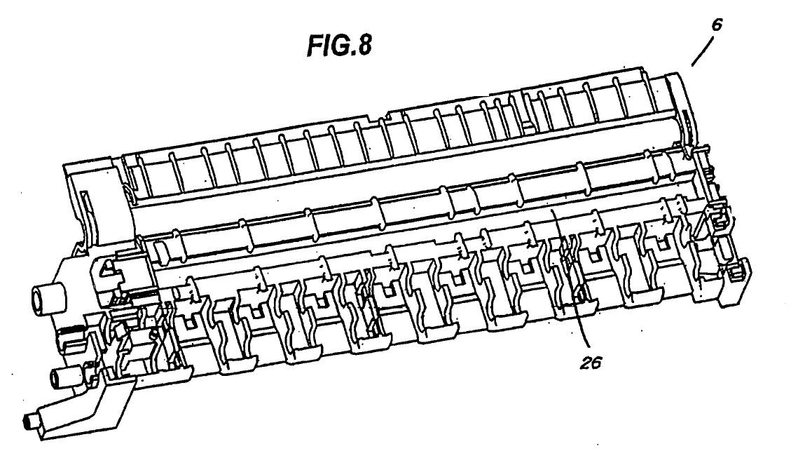

FIG. 9 is a side cross section showing a portion in association with the recording with no margin of the prior art.

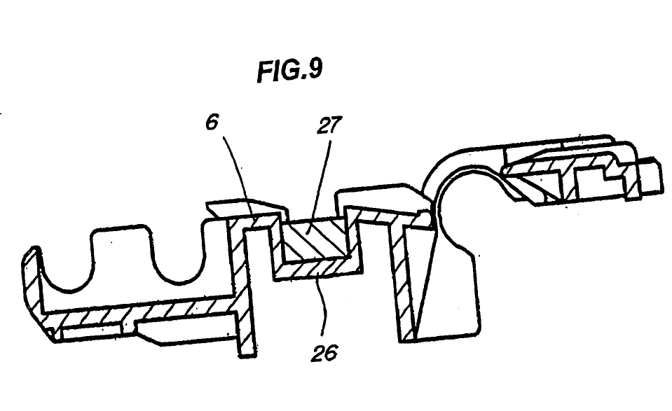

### DETAILED DESCRIPTION OF THE PREFERRED EMBODIMENTS

Hereinafter, referring to the drawings, preferred embodiments according to the invention are described in detail in an exemplifying manner. Such size, material, shape, and correlative positions of structural parts as set forth in the following embodiments can be modified according to the apparatus structure and various conditions to which this invention applies, and the scope of the invention is not intended to be limited to those as far as no special description is provided.

[First Embodiment]

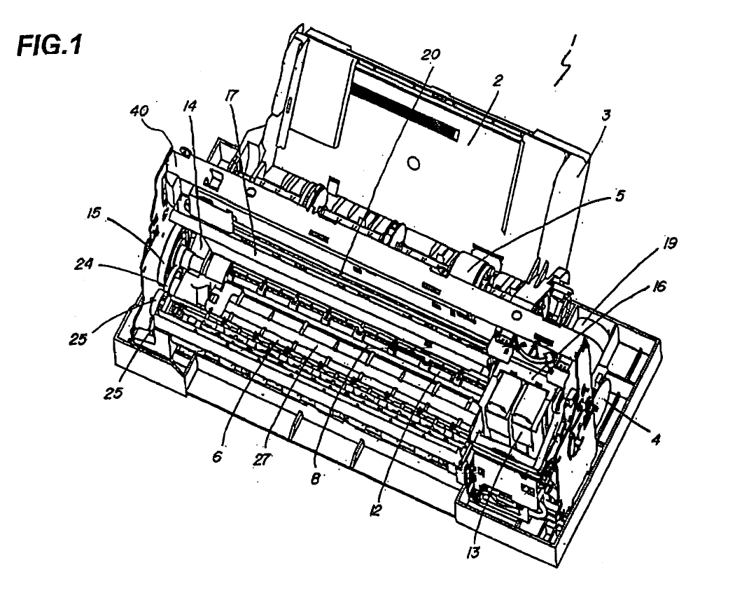

Hereafter, a recording apparatus according to the first embodiment is described in reference to FIG. 1 through FIG. 7. It is to be noted that in this embodiment an inkjet printer is exemplified as a recording apparatus for description.

First, an outline of the entire structure of the apparatus and operation of recording with no margin are described.

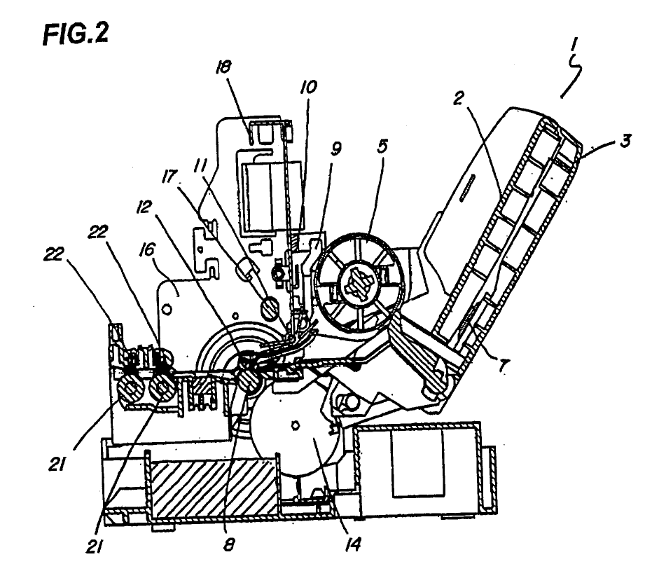

As shown in FIG. 1, a pressing plate 2 of a feeding apparatus 1 is supported pivotally to a feeding apparatus frame 3, and sheet bundles are stacked on a top face of the pressing plate 2. During sheet feeding, a feeding roller 5 rotates in association with a feeding motor 4 as a drive source, and the pressing plate 2 moves pivotally toward the feeding roller 5 in aid of a pressing plate spring 7 (see, FIG. 2) to press the sheet bundle to the feeding roller 5. Where the feeding roller 5 further rotates, the topmost sheet of the sheet bundle only is separated and fed to the downstream.

The sheet separated and fed by the feeding apparatus 1 is fed to a conveyance roller 8 according to further rotation of the feeding roller 5. The conveyance roller 8 has a structure in which ceramic particles are coated together with a binder material at around 30 micron meters on a surface of a metal shaft to maintain a proper frictional coefficient for conveying a sheet as a recording medium and in which the binder material is formed with pin holes when coated.

In FIG. 2, when the front end of the sheet separately fed from the feeding apparatus 1 pushes a senior lever 9 disposed between the feeding roller 5 and the conveyance roller 8, the sensor lever 9 is pivotally moved, and when the sensor lever 9 moves beyond a sheet sensor 10, the front end of the sheet is detected. The rear end of the sheet is detected by entry of the sensor lever 9 to the sheet sensor 10.

The sheet is conveyed in a prescribed amount with a feeding roller 5 on the basis of the detected results of the front end of the sheet described above, and hits a nipping portion formed of a contact between the conveyance roller 8 and a pinch roller 12 urged to the conveyance roller 8 by a pinch roller spring 11. The sheet is further conveyed in a proscribed amount by the feeding roller 5 to curve the front end of the sheet, thereby pushing the front end of the sheet to the nipping portion, and rendering registration operation completed.

After the completion of the registration operation, the sheet is conveyed on a platen 6 by the conveyance roller 8, and is held by the top surface of the platen 6 at a position in opposition to an mounted surface of ink discharging nozzles of a recording head 13 serving as a recording means. The conveyance roller 8 is rotated via a conveyance roller gear 15 by a stepping motor 14 as a drive source.

Images are subsequently formed upon scanning a carriage 16 as discharging ink droplets out of the recording head 13 mounted detachably on the carriage 16 across the sheet supported on a sheet passing surface of the platen 6. The carriage 16 is supported as capable of scanning with a guide rail 18 made of a guide shaft 17, and a metal chassis 40 of the apparatus body, and is driven via a timing belt 20 by drive from a carriage motor 19.

It is to be noted that the inkjet recording method is used in which ink is discharged from the recording head as described above as a means for recording in this apparatus. That is, this recording head has plural fine orifices, a fluid route, an energy operation section formed at a part of the fluid route, and an energy generating means for generating energy for producing droplets to be operated to a fluid in the operation section.

As an energy generating means for generating such energy, exemplified are a recording method using electro-mechanical converter such as piezo devices, a recording method using an energy generating means discharging droplets by operation of generated heats upon heat generation from radiation of electromagnetic wave such as a laser or the like, or a recording method using an energy generating means discharging fluid upon heating the fluid with an electro-thermal converter such as a heating device having a beat generating resistor.

A recording head used for the inkjet recording method in which fluid is discharged by thermal energy, among those, is able to make high resolution recording because the orifices for forming discharged droplets upon discharging the droplets for recording can be arranged with a high density. A recording head using the electro-thermal converter as an energy generating means, among those, advantageously can be readily made compact, readily mounted with a high density, and made with reduced manufacturing costs.

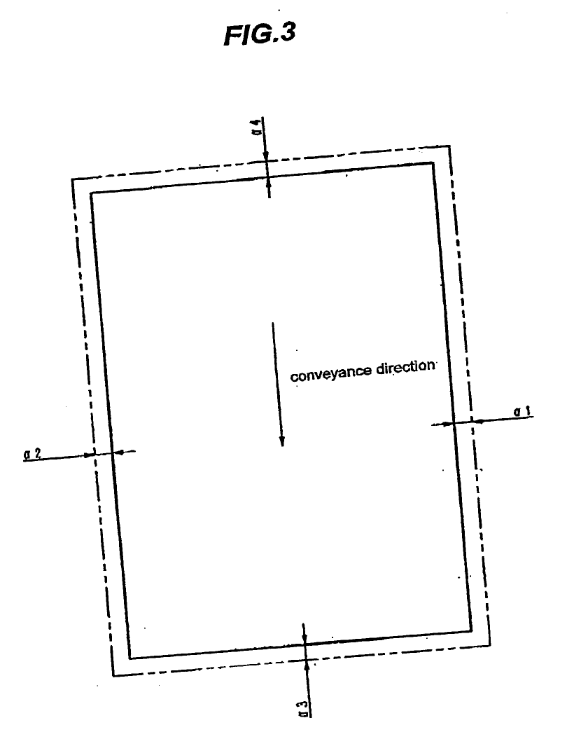

It is to be noted that in this embodiment, as a discharging structure of the ink, recording is made by energizing the electro-thermal converter in accordance with a recording signal and by growing and contracting bubbles generated at the ink in utilizing film boiling occurring in the ink from the thermal energy to discharge the ink out of the orifices.

Where recording with no margin is made to a sheet, a recording with no margin is realized by making recording as to protrude by prescribed amounts a1 to a4 in a manner shown with a double dotted chain line from four sheet edges with respect to an actual sheet shown with a solid line as shown in FIG. 3. The prescribed amounts a1 to a4 are set in consideration of sheet conveyance accuracy and sheet cutting accuracy, and in fact, a distance of 2 to 3 mm is proper

Finally, the sheet on which the image formation is completed is delivered to the exterior of the apparatus by a delivery roller 21 and a driven spur 22 pushed to the delivery roller 21 with a spur spring not shown. The delivery roller 21 is rotated via the conveyance roller gear 15, an intermittent gear 24, and a delivery roller gear 25 by the stepping motor 14 as a drive source.

Next, a structure of an opening for the platen 6 for holding a platen ink absorbing material 27 is described.

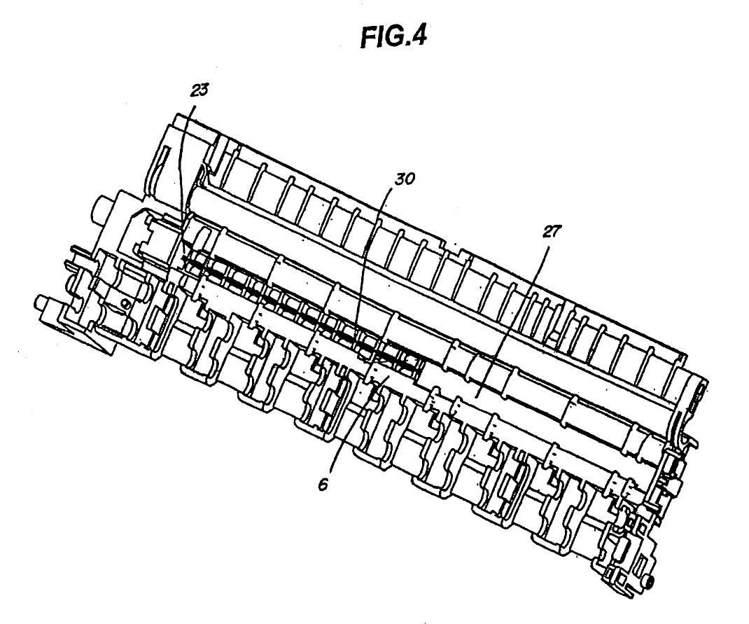

As shown in FIG. 4 to FIG. 6, the platen ink absorbing material 27 is held on a wall surface 23 extending substantially vertically downward from the opening formed on a sheet passing surface of the platen 6 as well as on a top surface of a grid shaped rib 30 extending substantially vertically downward in a way connecting the wall face 23 at a midway of the wall face 23.

With execution of the recording with no margin, most of ink droplets discharged at position protruded from the sheet, arrive at a surface of the platen ink absorbing material 27. The ink arriving at the platen ink absorbing material 27 gradually immerses in directing downward in the platen ink absorbing material 27 by the self-weight. The material of the platen ink absorbing material 27 may be a highly foamed urethane of a low density or the like to make better the ink immersing property.

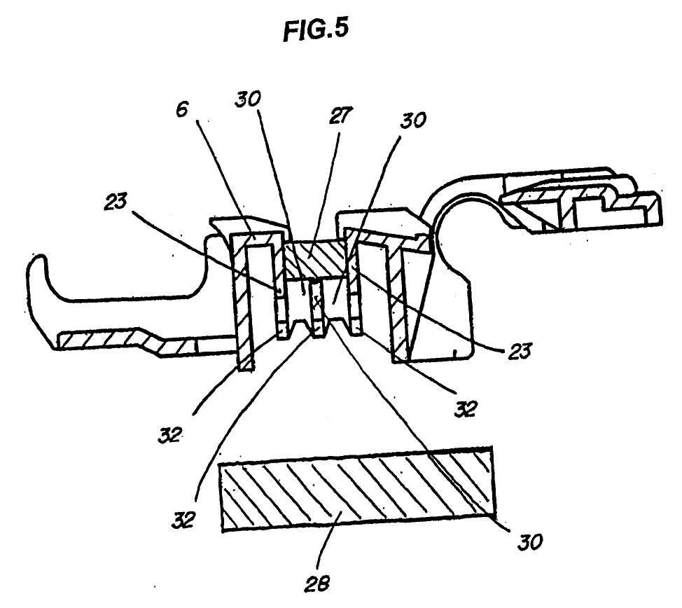

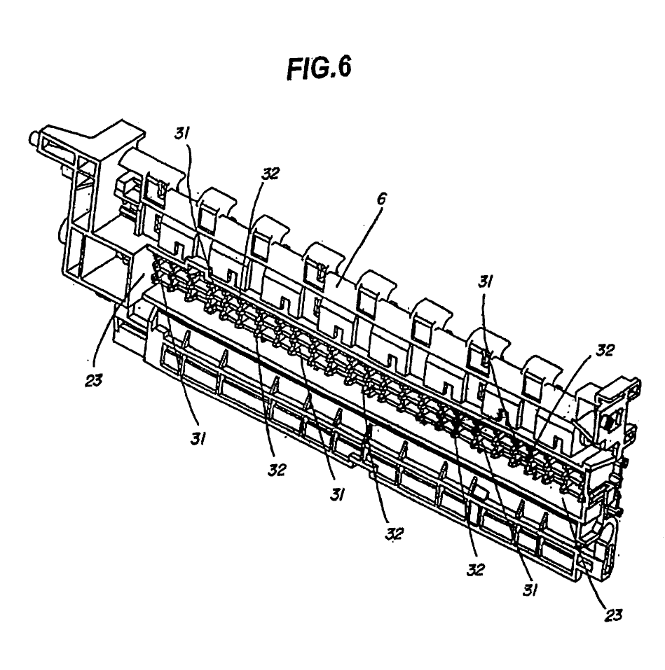

The ink remained at a lower portion of the platen ink absorbing material 27 moves downward through plural corners 31 (see, FIG. 6) formed at the grid shaped rib 30 from the top surface of the grid shaped rib 30 in contact with a bottom surface of the platen ink absorbing material 27 by operation of surface tension force. The ink reaching the bottom of the grid shaped rib 30 becomes droplets, and drop and are absorbed in an apparatus ink absorbing material 28 formed further below. Formation of protrusions 32 at the intersections of the lower surface of the grid shaped rib 30 structurally promotes ink reaching the lower surface of the grid shape rib 30 via the corners 31 to be integrated and dropped (see, FIG. 5).

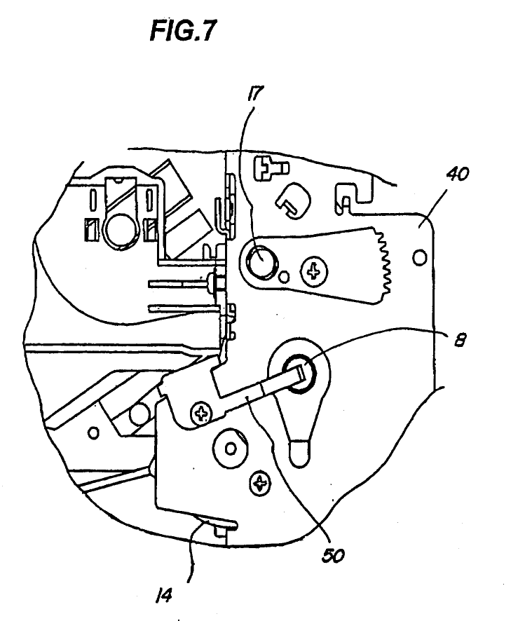

Furthermore, this embodiment has a structure that the conveyance roller 8 as a conveyance rotary body located on an upstream side in the recording medium conveyance direction with respect to the opening of the platen 6 is structured to be made conductive to the metal chassis 40 of the apparatus body. More specifically, as shown in FIG. 7, the conveyance roller 8 is structured to be made conductive to the metal chassis 40 of the apparatus body via a grounding spring 50 as a plate shaped conductor. It is to be noted that in this embodiment the grounding spring 50 as an urging member (spring member) made of SUS304CSP or the like serving as a plate shape conductor is exemplified but this invention is not limited to this.

The grounding spring 50 is attached to the chassis so as to urge the end face of the conveyance roller 8 in a thrust direction, or the shaft direction of the conveyance roller 8. The grounding spring 50 is attached to the metal chassis 40 by fastening screws together with other parts attached to the metal chassis 40 (or the stepping motor 14 as shown in FIG. 7 in this embodiment).

According to the above structure, where a sheet built up with static electricity from frictions among sheets or between the sheets and the feeding rollers is conveyed, the static electricity built up in the sheet passes through the pin holes in the binder material of the conveyance roller 8 and flows from the metal shaft via the grounding spring 50 to the metal chassis 40, thereby removing the static electricity built up in the sheet. Accordingly, a member such as a discharging blush or the like is not necessary to be separately provided for discharging the static electricity from the sheet. This apparatus, though having an inexpensive structure removing the static electricity from the static built sheet, can prevent the sheet from messing upon attachments on the sheet back side of ink droplets other than those arriving at the surface of the platen ink absorbing material 27 and droplets rebounded at a time of the arrival to the platen ink absorbing material 27, from discharging to the area protruded from the sheet during the no margin recording.

Because the grounding spring 50 is made of a leaf spring, the spring 50 can obtain a large contact area to the end surface of the conveyance roller 8 in comparison with a wire, so that the conducting state can be stabilized as well as that occurrence of mechanical noises and durability problems during operation can be avoided by dispersing the pressure of the contact portion.

The spring is urged to the end surface of the conveyance roller 8, thereby reducing the load torque to the stepping motor 14 in comparison with the structure that a spring urges to the outer diameter of the conveyance roller 8, and thereby realizing compact space and easiness in assembling.

[Other Embodimens]

In the embodiment described above, as a structure that the conveyance roller 8 as a conveyance rotary body located on an upstream side in the recording medium conveyance direction of the opening of the platen 6 is made conductive to the metal chassis 40 of the apparatus body, exemplified is a structure that the conveyance roller 8 is made conductive to the metal chassis 40 of the apparatus body by the grounding spring serving as a plate shaped conductor, but this invention is not limited to this.

For example, in FIG. 1, where hearing members, not shown, secured to the metal chassis 40 for supporting the opposite ends of the conveyance roller 8 are formed of annealed bearings based on iron or cupper, or plastic materials having a higher conductivity upon mixture of carbon or the like, the conveyance roller 8 may be made conductive to the metal chassis 40 of the apparatus body by the bearing members for the roller. With this structure, substantially the same effect can be expected as in the first embodiment described above.

Moreover, with the structure of the conveyance roller, where the binder material coated together with the ceramic material for ensuring the frictional coefficient is made of a material of non-insulator such as a metal powder or the like to render static electricity discharge to the metal chassis 40 from the surface of the conveyance roller 8, substantially the same effect can be expected as in the first embodiment described above.

In the embodiment described above, exemplified is a case of the inkjet recording apparatus using a single recording head, but this invention is not limited to this and is applicable to, e.g., an inkjet recording apparatus for color recording using plural recording heads making recording with multicolor inks, an inkjet recording apparatus for grayscale recording using plural recording heads for recording with inks in the same color but different in density, notwithstanding the number of the recording heads, and the same advantages can be obtained.

As a recording means (recording head), this invention is applicable to, e.g., a head of a cartridge type in which the recording head and the ink tank are made united, a structure that the recording head and the ink tank are made separated and connected with an ink supplying tube, regardless the structure of the recording means and the ink tank, and the same advantages can be obtained.

It is to be noted that in a case where the invention is applied to an inkjet recording apparatus, it is applicable to an apparatus using a recording means employing an electro-mechanical converter such as piezo device Or the like and, inter alias, it brings great advantages for an inkjet recording apparatus using a recording means of a method discharging inks utilizing thermal energy. This is because, with this method, high density and high resolution of recording can be achieved.

This invention is also effectively applicable to a recording head of a full line type having a length corresponding to a maximum width of the recording medium recordable at the recording apparatus. Such a recording head can be of a structure satisfying the length by a combination of plural recording heads, or of a structure of a single recording head formed as a united body. In addition, this invention is effective in a case using a recording head of a serial type described above, a recording head secured to an apparatus body, a recording head of a chip type that is replaceable for allowing an electrical connection to the apparatus body upon mounted on an apparatus body and allowing ink supplying from the apparatus body, and a recording head of a cartridge type in which an ink tank is formed unitedly to the recording head itself.

About the kind and number of the recording heads mounted on the carriage, only one may be formed corresponding to a monochrome ink, as well as heads in a plural number may be formed corresponding to the plural inks different in recording colors and densities. That is, although the recording mode of the recording apparatus may be not of a recording mode of only the main color such as black, the mode can be constituted of a combination of the plural recording heads unitedly constituting the recording head, and this invention is applicable to an apparatus having at least one of the multiple colors different in color or full color with mixing colors.

As a product of the inkjet recording apparatus described above, it can be, e.g., an image output terminal apparatus for information processing apparatus such as a computer, and further, an inkjet input and output apparatus capable of mounting a scanner or the like other than the recording head onto the carriage, a photocopier in combination with a reader or the like, and a facsimile machine having a transmitting and receiving function.

What is claimed is:

1. A recording apparatus recording an image by dischargeing an ink, comprising:
a recording means for being recordable to at least one edge of a recording medium without any margin;
an receiving portion for receiving an ink droplet discharged at a position protruded from the recording medium;
a conveyance rotary body located on an upstream side of the receiving portion in a conveyance direction of the recording medium,
wherein the conveyance rotary body is made conductive to an apparatus body.

2. The recording apparatus according to claim 1, wherein the receiving portion is an opening formed on a face of a platen for carrying the recording medium.

3. The recording apparatus according to claim 1, wherein the conveyance rotary body is made conductive to a chassis of the apparatus body via a plate shape conductive member.

4. The recording apparatus according to claim 2, wherein the plate shape conductive member is an urging member attached to the chassis as to urge an end surface of the conveyance rotary body in a thrust direction.

5. The recording apparatus according to claim 3, wherein the plate shape conductive member is attached to the apparatus body via a screw together with another member to be attached to the apparatus body.

6. The recording apparatus according to claim 1, wherein the conveyance rotary body is made conductive to a chassis of the apparatus body via a bearing member of the conveyance rotary body.

7. The recording apparatus according to any one of claim 1 to 6, wherein the conveyance rotary body is a conveyance roller structured of a metal shaft coated with mainly ceramic particles together with a binder material.

8. The recording apparatus according to claim 7, wherein the binder material has a structure forming fine pin holes when coated.

9. The recording apparatus according to claim 7, wherein the binder material is structured of non-insulating material.

10. The recording apparatus according to claim 7, wherein the binder material includes a metal powder.
